(19) United States
(12) Patent Application Publication
(10) Pub. No.: US 2015/0273593 A1
(43) Pub. Date: Oct. 1, 2015

(54) Chuck With Separate Retainer Parts

(71) Applicant: MEIKO MACHINE CO., LTD., Izumi-shi (JP)

(72) Inventor: Toshifumi NAKAI, Izumi-shi (JP)

(73) Assignee: MEIKO MACHINE CO., LTD., Izumi-shi (JP)

(21) Appl. No.: 14/227,518

(22) Filed: Mar. 27, 2014

(51) Int. Cl. B23B 31/117

(52) U.S. Cl. CPC B23B 31/1177; B23B 2270/06; B23B 2260/116

(57) ABSTRACT

A chuck (1) for a tool which is attached to a clamped part (8) of the main unit (2) of the chuck, wherein a retainer (3) for holding a large number of needle rollers (32) around the clamped part and a clamping sleeve (5) are rotated to clamp and fix the tool in the attached state. The retainer is composed of four separate retainer parts (4a to 4d), and the separate retainer parts have a movement adjusting mechanism that allows the separate retainer parts to move to appropriate clamping positions. Movement of the separate retainer part located closest to the tip end of the retainer is limited.

### BACKGROUND OF THE INVENTION

1. Field of the Invention

The present invention relates to a chuck that attaches a tool, such as a drill or an end mill, to a machine tool.

2. Description of the Related Art

FIGS. 10(a) through 11(b) show a conventional chuck 101. The conventional chuck 101 comprises a cylindrical clamped part 108 and a sleeve-shaped retainer 103 holding a large number of needle rollers 132 and a clamping sleeve 105 provided around the clamped part 108. As the clamping sleeve 105 and the retainer 103 are rotated to move toward the root end of the clamped part 108 (leftward in FIGS. 10(a) through 11(b)), the clamped part 108 with a tool inserted and attached in a housing part 123 thereof through an attachment hole 122 is clamped and fixed in the attached state.

FIGS. 10(a) and 10(b) show a non-clamping state where the clamped part 108 is not clamped, and FIGS. 11(a) and 11(b) shows a clamped state where the clamped part 108 is clamped.

As shown in FIG. 11(b), when the retainer 103 clamps the clamped part 108, the retainer 103 is located on a surface 121 of the clamped part 108 in a middle area between the tip end and the root end of the clamped part 108. Then, there remain non-clamped parts 161 of the surface 121 of the clamped part 108 on the tip end side and the root end side of the clamped part 108. Besides, the retainer 103 may completely move to the root end of the clamped part 108 (not shown), and in that case, there remains a wide non-clamped part 161 on the tip end side.

When a machine tool is activated, a small vibration commonly referred to as chatter can occur to hinder precise machining. It is considered that this is because of the non-clamped part 161 at the tip end of the clamped part 108.

In addition, the clamping force occurs at the part where the retainer 103 is located, the clamping force cannot be uniformly applied to the clamped part 108.

To prevent the vibration of the tool described above, there is a technique of clamping and fixing the clamped part with two separate retainers located at rearward and frontward positions (see Patent Literature 1, for example).

Patent Literature 1

Japanese Utility Model Laid-Open No. 59-62906

To prevent a small vibration referred to as chatter of a tool, the clamping force needs to be produced at the tip end of a clamped part. In addition, there is a demand for a chuck that exerts a stable clamping force by uniformly clamping the whole of the clamped part at which the chuck is held.

With the chuck described in Patent Literature 1, clamp rings on a clamp sleeve at frontward and rearward positions rotate and move toward the center of the clamp sleeve from the frontward and rearward positions. With this configuration, the clamping force cannot be produced at least in the vicinity of the attachment hole of the chuck, and a uniform clamping force cannot be exerted on the clamped part.

### BRIEF SUMMARY OF THE INVENTION

In view of such circumstances, a chuck according to the present invention comprises a main unit including an attachment part to be attached to a machine tool and a cylindrical clamped part in which a tool is to be attached, a sleeve-shaped retainer that is attached to surround the clamped part and has a plurality of roller holding grooves formed in a circumferential surface thereof, a plurality of needle rollers having a predetermined length being disposed in the roller holding grooves, and a sleeve-shaped sleeve attached to surround the clamped part and the retainer, the clamping sleeve and the retainer rotate around the clamped part to move to a clamping position, the clamping sleeve clamps and fixes the attached tool in the clamped part with the needle rollers of the retainer interposed therebetween, the retainer comprises a plurality of separate retainer parts, and each separate retainer part has a movement adjusting mechanism that allows the separate retainer part to move a different distance than another separate retainer part during rotation in a clamping direction.

Preferably, the roller holding grooves are groove bodies having a predetermined length conforming to the shape of the needle rollers, the longitudinal direction of the grooves is inclined at an inclination angle toward the direction of rotation of the retainer with respect to the axial direction of the retainer, and the movement adjusting mechanism is realized by setting the inclination angles of the separate retainer parts at different angles.

Preferably, the inclination angle of the separate retainer part of the separate retainer parts that is closest to an attachment hole is 0 degrees or an inclination angle in the opposite direction to the direction of rotation of the retainer.

With the separate retainer parts and the movement adjusting mechanism according to the present invention, the separate retainer parts can be positioned at appropriate points on the clamped part during clamping. Therefore, a uniform clamping force can be produced over the whole of the clamped part, and the tool can be stably attached.

According to the present invention, the distance over which each separate retainer part moves can be adjusted by differently setting the inclination angle of the separate retainer part. Thus, the distance over which each separate retainer part moves can be changed in a simple manner without the need for an additional member.

According to the present invention, movement of the separate retainer part located closest to the tip end toward the root end is limited, so that formation of a non-clamped part at the tip end of the clamped part can be prevented. Therefore, a small vibration of the tool, commonly referred to as chatter, can be prevented.

### BRIEF DESCRIPTION OF THE SEVERAL VIEWS OF THE DRAWINGS

FIG. 1 is an exploded perspective view showing an example of members of a chuck according to the present invention.

FIGS. 2(a) and 2(b) are diagrams showing an example of the chuck according to the present invention, FIG. 2(a) being a partially cross-sectional view of the whole of the chuck, and FIG. 2(b) being a partial enlarged cross-sectional view of a part surrounded by the alternate long and two short dashes line in FIG. 2(a).

FIGS. 3(a) and 3(b) are diagrams showing an example of a clamping state of the chuck according to the present invention, FIG. 3(a) being a partially cross-sectional view of the whole of the chuck, and FIG. 3(b) being an enlarged cross-sectional view of a part surrounded by the alternate long and two short dashes line in FIG. 3(a).

FIGS. 4(a) and 4(b) are diagrams showing an example of separate retainer parts used in the chuck according to the present invention, FIG. 4(a) being a general perspective view of the separate retainer parts abutting against each other, and FIG. 4(b) being a general perspective view of the separate retainer parts separated from each other.

FIGS. 5(a) to 5(d) are diagrams showing an example of roller holding grooves of the chuck according to the present invention, FIGS. 5(a) to 5(d) being enlarged front views of the roller holding grooves with different inclination angles.

FIG. 6(a) is an enlarged front view showing another embodiment in which the inclination angle of the roller holding grooves is 0 degrees, and FIG. 6(b) is an enlarged front view showing another embodiment in which the inclination angle of the roller holding grooves is an inclination angle in the opposite direction to the direction of rotation.

FIGS. 7(a) and 7(b) are diagrams showing separate retainer parts according to second and third embodiments used in the chuck according to the present invention, FIG. 7(a) being a general perspective view of two separate retainer parts each having two rows of roller holding grooves, and FIG. 7(b) being a general perspective view of two separate retainer parts, one having three rows of roller holding grooves, and the other having one row of roller holding grooves.

FIG. 8 is a diagram showing separate retainer parts according to a fourth embodiment used in the chuck according to the present invention, which is a general perspective view of three separate retainer parts each having one row of roller holding grooves.

FIGS. 9(a) and 9(b) are diagrams showing separate retainer parts according to fifth and sixth embodiments used in the chuck according to the present invention, FIG. 9(a) being a general perspective view of two separate retainer parts, one having one row of roller holding grooves, and the other having two rows of roller holding grooves, and FIG. 9(b) being a general perspective view of two separate retainer parts, one having two rows of roller holding grooves, and the other having one row of roller holding grooves.

FIGS. 10(a) and 10(b) show an example of a conventional chuck in a non-clamping state, FIG. 10(a) being a partially cross-sectional view of the whole of the chuck, and FIG. 10(b) being a partial enlarged cross-sectional view of a part surrounded by an alternate long and two short dashes line in FIG. 10(a).

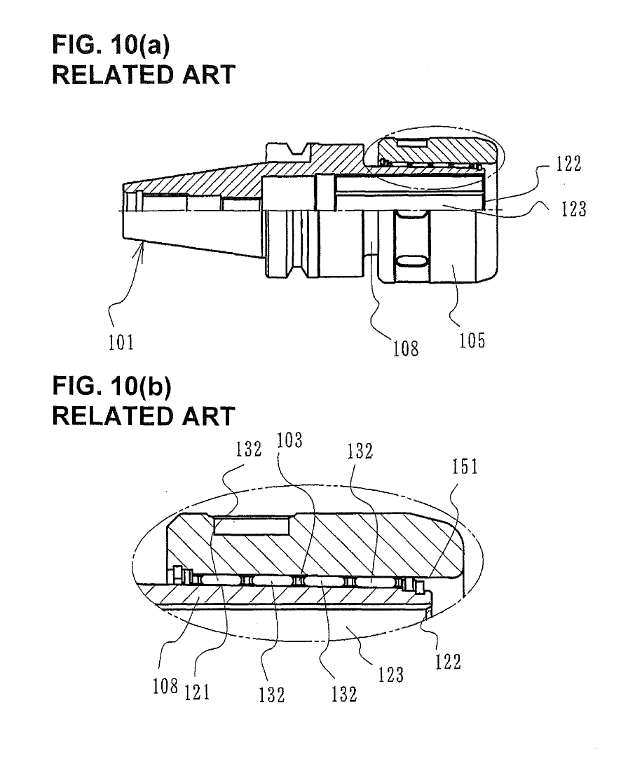

FIGS. 11(a) and 11(b) show an example of the conventional chuck in a clamping state, FIG. 11(a) being a partially cross-sectional view of the whole of the chuck, and FIG. 11(b) being a partial enlarged cross-sectional view of a part surrounded by an alternate long and two short dashes line in FIG. 11(a).

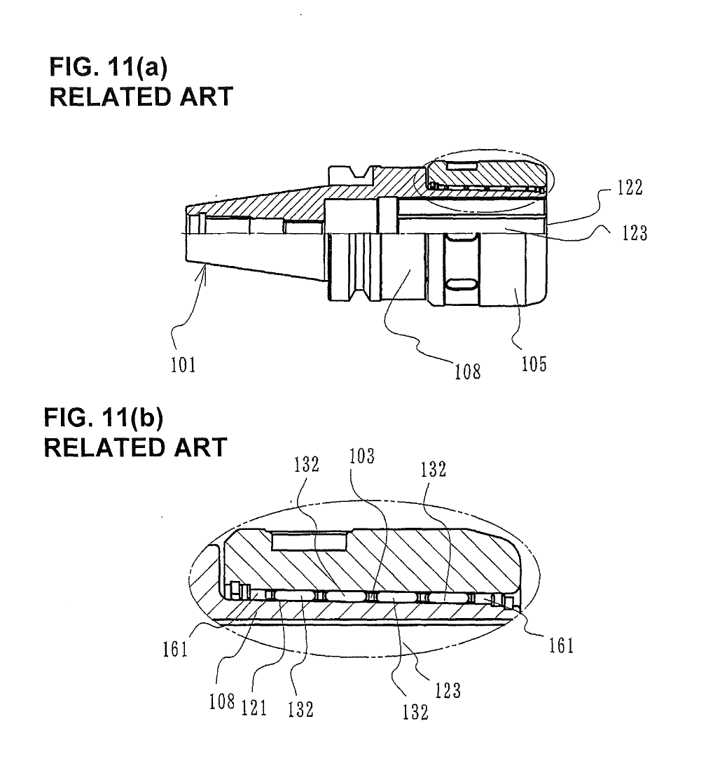

### DETAILED DESCRIPTION OF THE INVENTION

Embodiments of the present invention will be described with reference to the drawings.

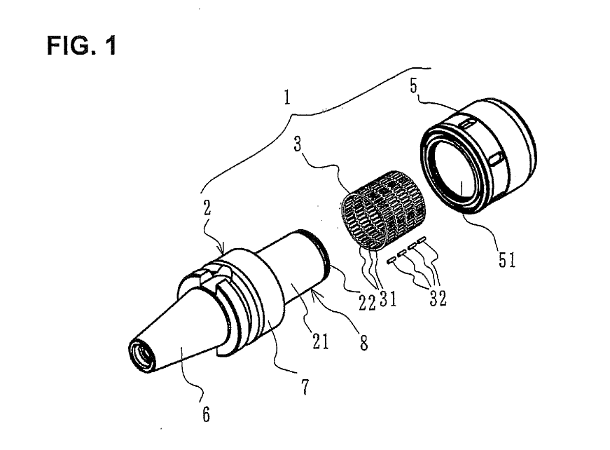

A chuck 1 according to the present invention is used to attach a tool, such as a drill or an end mill, to a machine tool, such as a milling machine or a machining center, and comprises a main unit 2, a retainer 3 and a clamping sleeve 5 as shown in FIG. 1.

The main unit 2 has, on one end, an attachment part 6 having a substantially conical shape with an opening at the tip end thereof. On the other end, the main unit 2 has a clamped part 8 having a sleeve shape. In a middle part of the main unit 2 between the attachment part 6 and the clamped part 8, a grip part 7 having a flange shape is formed for a user to hold the chuck 1. The chuck 1 can be attached to a machine tool, such as a milling machine or a machining center, by attaching the attachment part 6 to the machine tool. An attachment hole 22 is formed in the tip end (the right end in FIG. 1) of the clamped part 8, and a hollow housing part 23 is formed in the clamped part 8 and the grip part 7. A tool can be attached to the chuck 1 by introducing the tool into the housing part 23 through the attachment hole 22.

The clamped part 8 has a tapered surface 21, which is slightly inclined to form a tapered shape as it goes from the root end side toward the tip end side of the clamped part 8. The “root end side” of the clamped part 8 means the side of the clamped part 8 closer to the grip part 7, the “tip end side” means the side of the attachment hole 22, and this holds true for the following description.

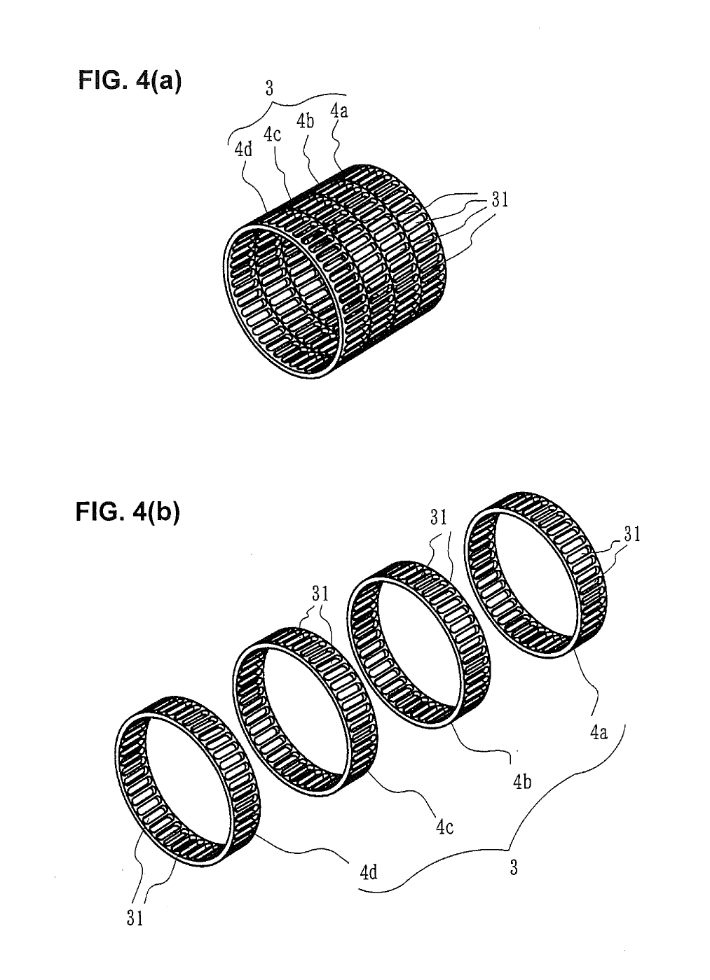

As shown in FIGS. 1 and 4(a), the retainer 3 is a sleeve-shaped member having a relatively small thickness and has a tapered circumferential surface that is slightly inclined to form a tapered shape as it goes from the root end side toward the tip end side, as with the surface 21 of the clamped part 8. The retainer 3 has a large number of roller holding grooves 31 formed in the circumferential surface thereof, in which a large number of cylindrical needle rollers 32 having a predetermined length are to be disposed.

The roller holding groove 31 has the shape of a groove having a predetermined length that conforms to the shape of the needle roller 32 and rotatably holds the needle roller 32. Once the retainer 3 is attached to the clamped part 8, the needle rollers 32 rotate in contact with the surface 21 of the clamped part 8.

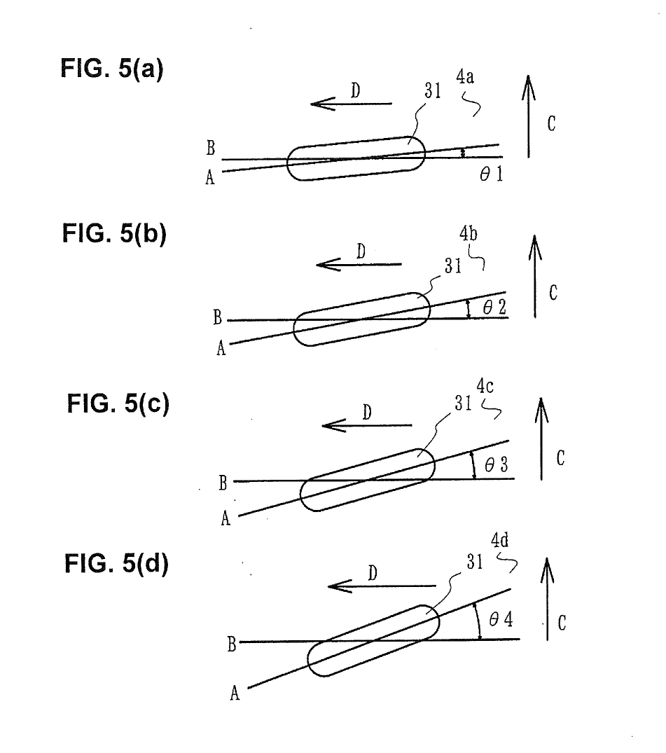

As shown in FIG. 5(a), the longitudinal direction A of the roller holding grooves 31 is slightly inclined (by an angle θ1) toward the direction of the arrow C, which is the direction of rotation of the retainer 3, with respect to the axial direction B of the retainer 3. When the retainer 3 rotates in the direction of the arrow C, the needle rollers 32 held in the roller holding grooves 31 rotate and exert a force to the retainer 3 to move in the direction of the arrow D.

The clamping sleeve 5 has a sleeve shape as with the retainer 3 and has a relatively great thickness so that the user can easily grip the clamping sleeve 5. As with the surface 21 of the clamped part 8 and the circumferential surface of the retainer 3, the clamping sleeve 5 has a tapered inner surface 51, which is inclined to form a tapered shape as it goes from the root end toward the tip end.

Attachment of the retainer 3 and the clamping sleeve 5 to the main unit 2 will be described.

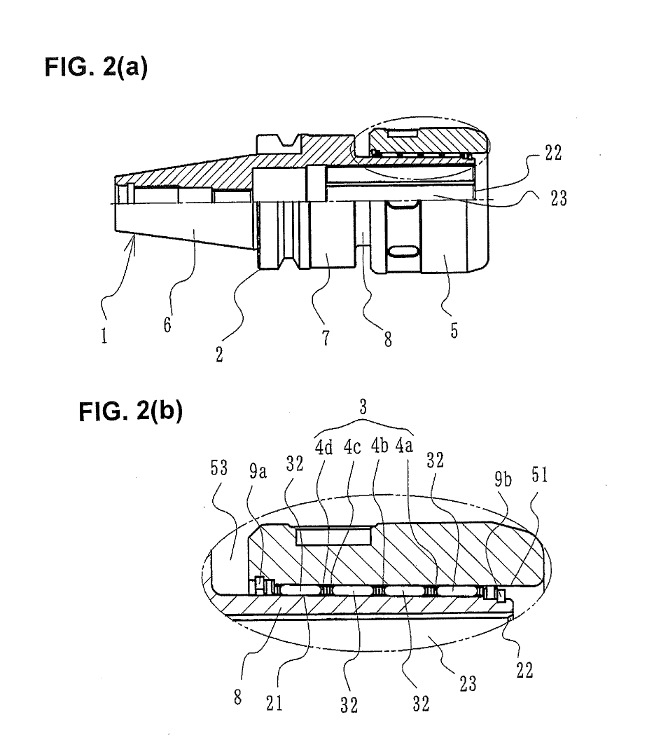

As shown in FIGS. 1 and 2(a), the retainer 3 is attached so as to surround the circumference of the clamped part 8, that is, in such a manner that the cylindrical clamped part 8 is positioned inside the sleeve-shaped retainer 3. As with the retainer 3, the clamping sleeve 5 is attached so as to surround the circumference of the clamped part 8 with the retainer 3 attached thereto.

To prevent the retainer 3 and the clamping sleeve 5 attached to the clamped part 8 from dropping off, drop-off preventing members 9a and 9b are provided. Specifically, as shown in FIG. 2(b), the drop-off preventing member 9a is disposed on the inner surface 51 of the clamping sleeve 5 at a position on the root end side, and the drop-off preventing member 9b is disposed on the surface 21 of the clamped part 8 at a position on the tip end side. The drop-off preventing members 9a and 9b support the retainer 3 and the clamping sleeve 5 so as to allow rotation of the retainer 3 and the clamping sleeve 5 around the clamped part 8 while preventing dropping off thereof. The drop-off preventing members 9a and 9b provide a space in which the retainer 3 can rotate and move. The drop-off preventing members 9a and 9b are drop-off preventing ring members.

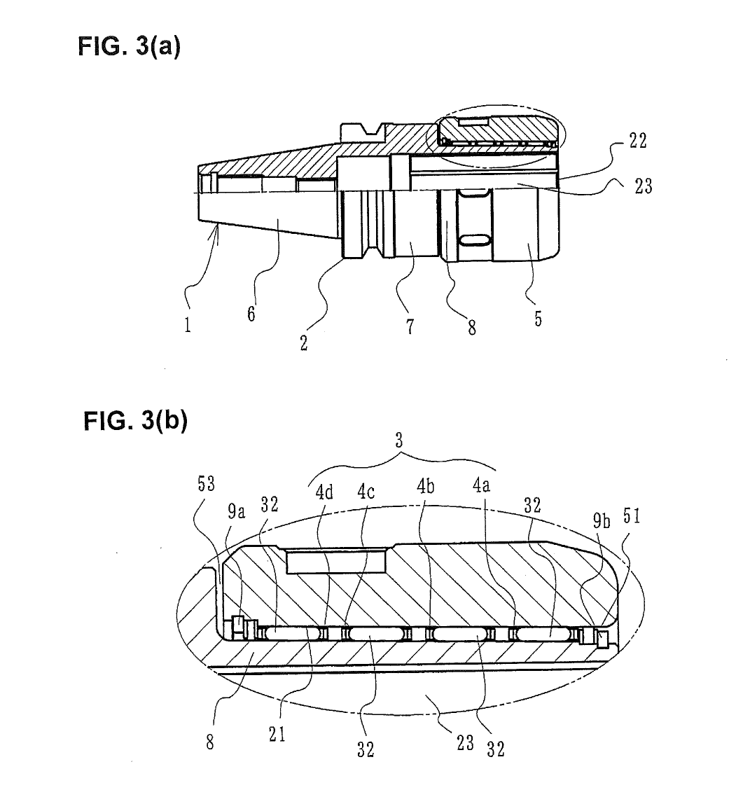

The chuck 1 shown in FIGS. 2(a) and 2(b) are in a non-clamping state where the chuck 1 does not clamp or fix any tool. This state is a state where the root end part of the clamping sleeve 5 is located apart from the grip part 7 of the main unit 2 by a predetermined distance, which is a movement stroke 53. In a clamping state, as shown in FIGS. 3(a) and 3(b), the clamping sleeve 5 and the retainer 3 have moved in the direction to the root end through the movement stroke 53 and are located close to the grip part 7.

The user can bring the chuck 1 into the clamping state by rotating the clamping sleeve 5 to rotate and move the clamping sleeve 5 and the retainer 3 into a clamping position on the root end side. This movement causes the clamping sleeve 5 to clamp the clamped part 8 with the needle rollers 32 interposed therebetween, because the surface 21 of the clamped part 8, the retainer 3 and the inner surface 51 of the clamping sleeve 5 have a tapered shape. In this way, the tool attached can be clamped and fixed.

With the chuck 1 according to this embodiment, the clamping sleeve 5 and the retainer 3 are moved toward the root end side into the clamping position, thereby clamping the clamped part 8 with the needle rollers 32 interposed therebetween. As described later, the retainer 3 comprises separate retainer parts 4a to 4d, and the separate retainer parts 4a to 4d have a movement adjusting mechanism. Therefore, as shown in FIG. 3(b), the needle rollers 32 can be distributed between the drop-off preventing members 9a and 9b, and the whole of the clamped part 8 can be uniformly clamped at appropriate clamping points. The separate retainer part 4a closest to the tip end is located close to the drop-off preventing member 9b on the tip end side, so that a part of the clamped part 8 close to the attachment hole 22 can be effectively clamped, and therefore, a vibration of the tool commonly referred to as chatter can be prevented.

Next, the separate retainer parts 4a to 4d will be described.

As shown in FIG. 4(a), the retainer 3 according to this embodiment has four rows of a large number of roller holding grooves 31 formed in the circumferential direction of the retainer 3, the four rows being arranged in the axial direction of the retainer 3. As shown in FIG. 4(b), the separate retainer parts 4a to 4d are separate parts of the retainer 3 and each have one of the four rows of roller holding grooves 31 formed in the circumferential direction.

As shown in FIGS. 4(a) and 2(b), in the non-clamping state, the separate retainer parts 4a to 4d according to this embodiment are arranged with the part 4a located closest to the tip end, the part 4b located next to the part 4a, the part 4c located next to the part 4b and the part 4d located closest to the root end, and abut against each other.

The separate retainer parts 4a to 4d forming the retainer 3 have no mechanism of coupling themselves to each other. Therefore, when the retainer 3 is attached to the clamped part 8, the separate retainer parts 4a to 4d can each move between the drop-off preventing members 9a and 9b on the opposite sides. In the non-clamping state shown in FIGS. 2(a) and 2(b), the space between the drop-off preventing members 9a and 9b is narrow, and the separate retainer parts 4 abut against each other. Once the separate retainer parts 4a to 4d abut against each other, the clamping sleeve 5 cannot further moved toward the tip end side. Thus, the retainer 3 serves as a stopper that prevents further movement of the clamping sleeve 5 toward the tip end side.

Next, the movement adjusting mechanism of the separate retainer parts 4a to 4d will be described.

As described above, the roller holding grooves 31 appropriately formed in the separate retainer parts 4a to 4d are slightly inclined toward the direction of rotation of the retainer 3 with respect to the axial direction of the retainer 3. The distance over which each of the separate retainer parts 4a to 4d moves during rotation is differently adjusted by setting the inclination angle of each separate retainer part at a different angle.

More specifically, as shown in FIG. 5(a), the inclination angle between the longitudinal direction A of the roller holding groove 31 in the separate retainer part 4a and the axial direction B of the retainer is denoted by θ1. Similarly, the inclination angles of the separate retainer parts 4b to 4d are denoted by θ2, θ3 and θ4, respectively, as shown in FIGS. 5(b) to 5(d). If the inclination angles θ1 to θ4 are set at different angles with θ1 being smaller than θ2, θ2 being smaller than θ3 and θ3 being smaller than θ4, the forces exerted to move the separate retainer parts 4a to 4d toward the root end while needle rollers 32 are rotating are also different with the force to move the part 4a being smaller than the force to move the part 4b, the force to move the part 4b being smaller than the force to move the part 4c and the force to move the part 4c being smaller than the force to move the part 4d. In this way, the distance over which each separate retainer part can be adjusted.

If the inclination angles θ1 to θ4 are equal to each other, the separate retainer parts 4a to 4d move the same distance. If the inclination angles are related according to θ1<θ2<θ3<θ4, the distances of movement of the separate retainer parts 4a to 4d to the respective predetermined points are also related to according to 4a<4b<4c<4d. Thus, as shown in FIG. 3(b), the separate retainer parts 4a to 4d move at certain intervals between the drop-off preventing members 9a and 9b, and the movement can be adjusted.

As described above, the separate retainer parts 4a to 4d move to the respective clamping points at appropriate intervals between the drop-off preventing members 9a and 9b and clamp and fix the clamped part 8 with the tool introduced into the housing part 23. Therefore, the clamping force can be uniformly applied to the clamped part 8, and the clamped part 8 can be stably clamped.

The inclination angles θ1 to θ4 shown in FIGS. 5(a) to 5(d) are exaggerated for the sake of clarity, and the actual inclination angles θ1 to θ4 are 1.5 degrees, 3 degrees, 6 degrees and 7.5 degrees, respectively. However, the inclination angles are not necessarily limited to these values and can be changed as required.

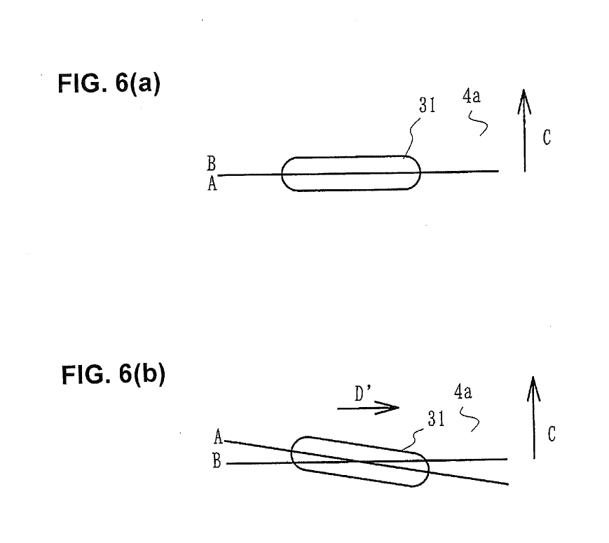

According to another embodiment, as shown in FIG. 6(a), of the separate retainer parts 4a to 4d, the angle between the longitudinal direction A of the roller holding grooves 31 of the separate retainer part 4a located closest to the tip end and the axial direction B is set at 0 degrees.

In that case, no force is exerted to move the separate retainer 4a toward the root end, and a part of the clamped part 8 close to the attachment hole 22 can be clamped.

According to another embodiment, as shown in FIG. 6(b), unlike the separate retainer parts 4b to 4d, the longitudinal direction A of the roller holding grooves 31 of the separate retainer part 4a is inclined in the opposite direction (direction D′) to the direction of rotation with respect to the axial direction B.

In that case, a force to move the separate retainer part 4a toward the tip end is exerted. Therefore, the separate retainer part 4a always exerts a biasing force to the drop-off preventing member 9b close to the attachment hole 22 of the clamped part 8 and can clamp and fix the involved part of the clamped part 8. As a result, a small vibration of the attached tool commonly referred to as chatter can be more appropriately prevented.

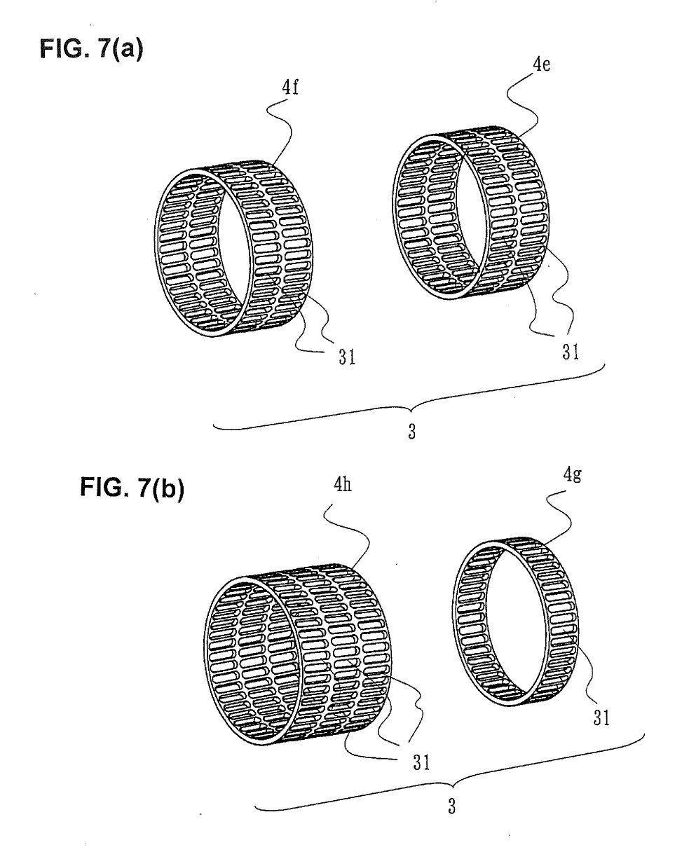

FIGS. 7(a) to 9(b) show second to sixth embodiments.

The second embodiment shown in FIG. 7(a) differs from the first embodiment in that the retainer 3 comprises two separate retainer parts 4e and 4f each having two rows of roller holding grooves 31 formed in the circumferential direction. The roller holding grooves 31 of the separate retainer parts 4f are inclined by 6 to 7.5 degrees with respect to the direction of rotation of the retainer 3. The roller holding grooves 31 of the separate retainer part 4e may be inclined by 0.5 degrees with respect to the direction of rotation of the retainer 3, may not be inclined, or may be inclined in the opposite direction to the direction of rotation. The inclination angles are not limited to the angles described above and can be changed as required.

The third embodiment shown in FIG. 7(b) differs from the first embodiment in that the retainer 3 comprises two separate retainer parts 4h and 4g, the separate retainer part 4h having three rows of roller holding grooves 31 formed in the circumferential direction, and the separate retainer part 4g having one row of roller holding grooves 31 formed in the circumferential direction. The inclination angles of the roller holding grooves 31 are the same as those in the second embodiment.

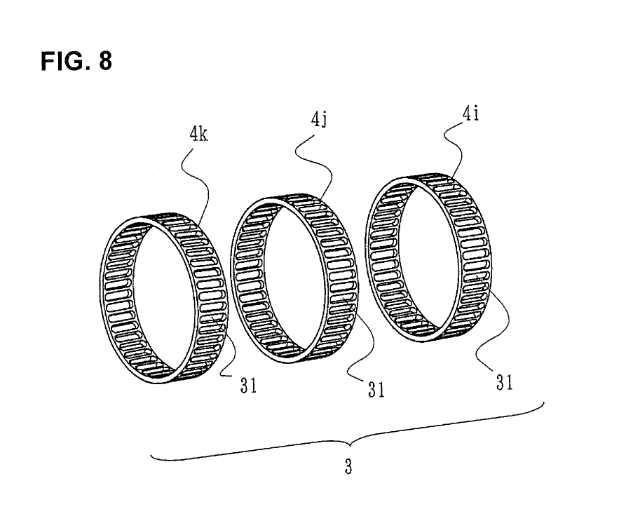

The fourth embodiment shown in FIG. 8 differs from the first embodiment in that the retainer 3 comprises three separate retainer parts 4i and 4k each having one row of roller holding grooves 31 formed in the circumferential direction. The roller holding grooves 31 of the separate retainer parts 4k are inclined by 6 to 12 degrees with respect to the direction of rotation of the retainer 3, and the roller holding grooves 31 of the separate retainer parts 4j and 4i may be inclined by 3 to 6 degrees and 0.5 degrees, respectively, with respect to the direction of rotation of the retainer 3, may not be inclined, or may be inclined in the opposite direction to the direction of rotation. The inclination angles are not limited to the angles described above and can be changed as required.

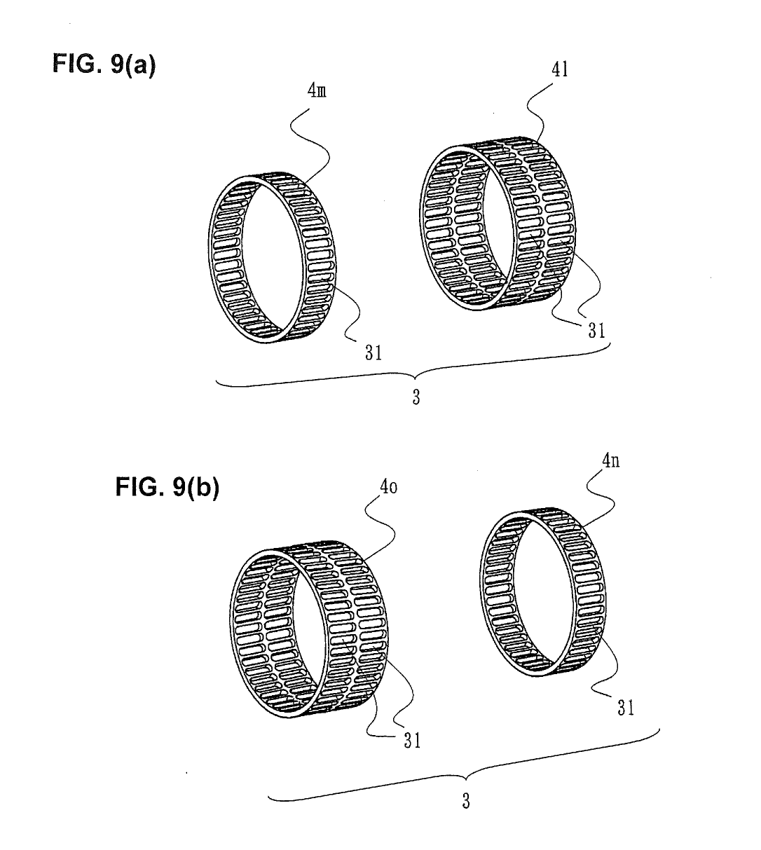

The fifth embodiment shown in FIG. 9(a) differs from the first embodiment in that the retainer 3 comprises a separate retainer part 4m having one row of roller holding grooves 31 formed in the circumferential direction and a separate retainer part 4l having two rows of roller holding grooves 31 formed in the circumferential direction. The roller holding grooves 31 of the separate retainer parts 4m are inclined by 6 to 12 degrees with respect to the direction of rotation of the retainer 3, and the roller holding grooves 31 of the separate retainer part 4l may be inclined by 0.5 degrees with respect to the direction of rotation of the retainer 3, may not be inclined, or may be inclined in the opposite direction to the direction of rotation.

The sixth embodiment shown in FIG. 9(b) differs from the first embodiment in that the retainer 3 comprises a separate retainer part 4o having two rows of roller holding grooves 31 formed in the circumferential direction and a separate retainer part 4n having one row of roller holding grooves 31 formed in the circumferential direction. The roller holding grooves 31 of the separate retainer part 4o are inclined by 6 to 12 degrees with respect to the direction of rotation of the retainer 3, and the roller holding grooves 31 of the separate retainer part 4n may be inclined by 0.5 degrees with respect to the direction of rotation of the retainer 3, may not be inclined, or may be inclined in the opposite direction to the direction of rotation. The inclination angles are not limited to the angles described above can be changed as required.

As described above, the number of separate retainer parts forming the retainer 3 and the inclination angle of the roller holding grooves 31 can be arbitrarily set and changed as required. However, the inclination angles of the roller holding grooves 31 of separate retainer parts closer to the root end, which move longer distances, have to be greater than the inclination angles of the roller holding grooves 31 of separate retainer parts closer to the tip end, which move shorter distances.

1. A chuck, comprising:
a main unit including an attachment part to be attached to a machine tool and a cylindrical clamped part in which a tool is to be attached;
a sleeve-shaped retainer that is attached to surround the clamped part and has a plurality of roller holding grooves formed in a circumferential surface thereof, a plurality of needle rollers having a predetermined length being disposed in the roller holding grooves; and
a clamping sleeve attached to surround the clamped part and the retainer,
wherein the clamping sleeve and the retainer rotate around the clamped part to move to a clamping position, the clamping sleeve clamps and fixes the attached tool in the clamped part with the needle rollers of the retainer interposed therebetween,
the retainer comprises a plurality of separate retainer parts, and
each separate retainer part has a movement adjusting mechanism that allows the separate retainer part to move a different distance than another separate retainer part during rotation in a clamping direction.

2. The chuck according to claim 1, wherein the roller holding grooves are groove bodies having a predetermined length conforming to the shape of the needle rollers,
the longitudinal direction of the grooves is inclined at an inclination angle toward the direction of rotation of the retainer with respect to the axial direction of the retainer, and
the movement adjusting mechanism is realized by setting the inclination angles of the separate retainer parts at different angles.

3. The chuck according to claim 2, wherein the inclination angle of the separate retainer part of the separate retainer parts that is closest to an attachment hole is 0 degrees or an inclination angle in the opposite direction to the direction of rotation of the retainer.
